(19) United States
(12) Patent Application Publication
(10) Pub. No.: US 2017/0318950 A1
(43) Pub. Date: Nov. 9, 2017

(54) TOOTHBRUSH HAVING CHAMBER FOR HOLDING TOOTHPASTE AND ALLOWING DISPENSING THEREOF

(71) Applicant: Gaylor Cope, Bullhead City, AZ (US)

(72) Inventor: Gaylor Cope, Bullhead City, AZ (US)

(21) Appl. No.: 15/006,500

(22) Filed: Jan. 26, 2016

(51) Int. Cl. A46B 11/00; A46B 9/04; B29C 45/16; B29L 31/42

(52) U.S. Cl. CPC A46B 11/001; B29C 45/1676; A46B 9/04; A46B 2200/1066; B29L 2031/425

(57) ABSTRACT

A toothbrush having a brush head with bristles extending therefrom, a handle having a toothpaste chamber therein, a valve configured to open and close an opening in the brush head, a passageway extending from the toothpaste chamber to the opening, and wherein at least a portion of the handle is fabricated of a pliable material such that toothpaste contained within the toothpaste chamber can be dispensed on to the brush head via the opening by application of pressure to the pliable portion of the handle.

### FIELD OF THE INVENTION

The embodiments of the present invention relate to a toothbrush having a chamber for holding and facilitating the dispensing of toothpaste onto the bristles of the toothbrush.

### BACKGROUND

Oral hygiene is extremely important. Besides keeping teeth healthy, brushing teeth has been shown to aid with heart disease, mouth disease and throat disease. Accordingly, brushing teeth twice a day is of paramount importance. In some instances, access to a toothbrush and toothpaste is challenging. For example, access to a toothbrush and toothpaste is challenging when traveling, working late, attending all-day events, during emergencies, participating in the armed forces and visiting hospitals. Children also tend to avoid brushing. Another issue relates to overused toothbrushes. That is, users tend to keep and use a toothbrush much too long and well after the toothbrush bristles have lost their effectiveness.

Thus, it would be advantageous to develop a readily available, disposable toothbrush having a chamber for containing toothpaste and a system for dispensing said toothpaste to overcome the shortcomings of conventional toothbrushes.

### SUMMARY

The embodiments of the present invention are directed to a toothbrush comprising a brush head having bristles extending therefrom, a handle defining a toothpaste chamber, a valve configured to open and close an opening in said brush head, a passageway extending from said toothpaste chamber to said opening in said brush head, and wherein at least a portion of said handle, is fabricated of a pliable material such that toothpaste contained within said toothpaste chamber can be dispensed on to said brush head via said opening by application of pressure to said pliable portion of said handle.

In one embodiment, the toothbrush may be fabricated using two-shot plastic injection molding whereby the handle may have first conventional rigid portions and second pliable portions. The valve, when closed, maintains unused toothpaste in condition for future use and prevents toothpaste leakage. In one embodiment, the chamber holds 2-4 ounces of toothpaste which is enough for multiple brushing sessions. In one embodiment, the toothbrush is intended to be disposed of after the contained toothpaste is exhausted. In another embodiment, the toothbrush contains enough toothpaste (e.g., 6+ ounces) rendering the toothbrush useful for much longer than a few brushing sessions.

Other variations, embodiments and features of the present invention will become evident from the following detailed description, drawings and claims.

### BRIEF DESCRIPTION OF THE DRAWINGS

FIG. 1 illustrates a side view of a toothbrush according to the embodiments of the present invention;

FIG. 2 illustrates a front view of the toothbrush according to the embodiments of the present invention;

FIG. 3 illustrates a rear view of the toothbrush according to the embodiments of the present invention;

FIG. 4 illustrates a cross-sectional side view of the toothbrush according to the embodiments of the present invention;

FIG. 5 illustrates a cross-sectional rear view of the toothbrush according to the embodiments of the present invention;

FIGS. 6A and 6B illustrate side and top views, respectively, of a slide valve according to the embodiments of the present invention;

FIGS. 6C and 6D illustrate top views of the slide valve in open and closed positions, respectively, according to the embodiments of the present invention;

FIG. 7 illustrates a cross-sectional view of the handle and chamber of the toothbrush according to the embodiments of the present invention;

FIG. 8 illustrates a cross-sectional view of the handle and passageway according to the embodiments of the present invention;

FIG. 9 illustrates a cross-sectional view of the brush head according to the embodiments of the present invention; and

FIGS. 10A-10F illustrate exemplary cross-sectional views of toothbrush handles according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

The toothbrush detailed herein may be fabricated of any number of materials, including, for example, plastics, polymers and/or composites, and may be fabricated using any number of techniques, including, for example, conventional injection molding, two-shot injection molding machining and/or additive processes. One of the primary benefits of the toothbrush detailed herein relates to the simplicity of the design which eliminates the use of plungers, dials, plugs, springs, etc. The simplicity permits the toothbrush to be made inexpensively allowing it to be a disposable commodity.

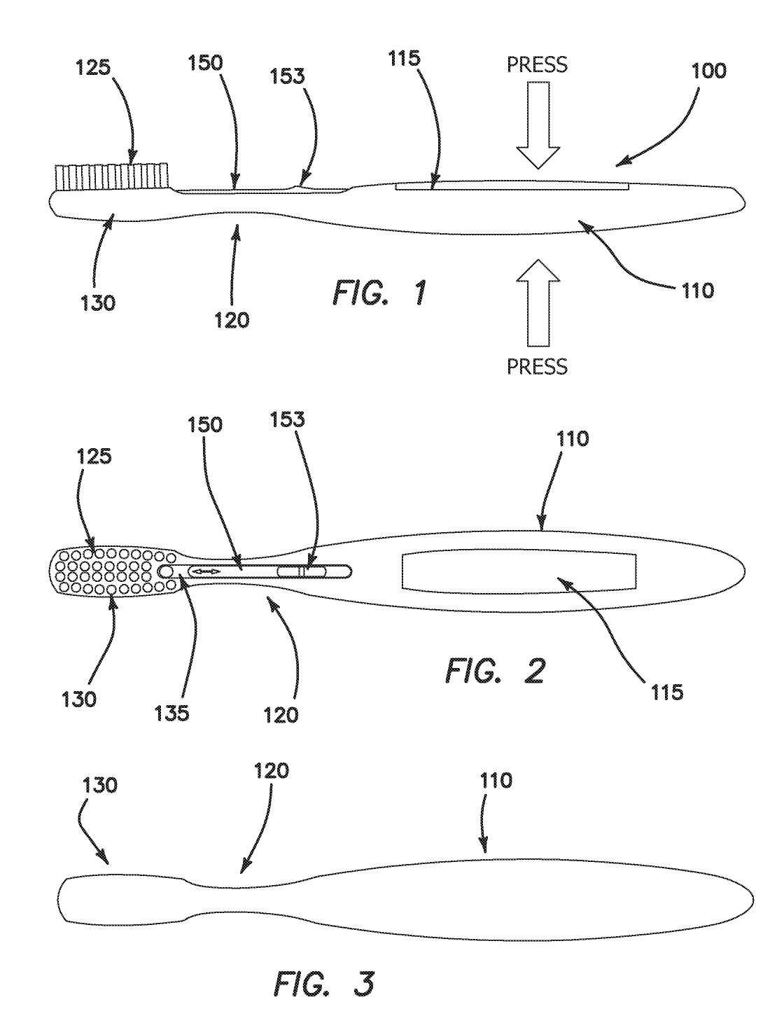

FIGS. 1-3 illustrate side, front and rear views, respectively, of a toothbrush 100 according to the embodiments of the present invention. The toothbrush 100 comprises a handle 110, shank 120 and brush head 130 as do most conventional toothbrushes. The toothbrush 100 also includes an internal toothpaste chamber 140 defined by said handle 110. It is conceivable that the toothpaste chamber 140 may extend into the shank 120 and/or brush head 130. In one embodiment, the toothpaste chamber 140 is dimensioned to hold 2-4 ounces of toothpaste. The amount of toothpaste may be lesser or greater and to some degree influenced by the dimensions of the handle 110 which may be dimensioned as needed by the manufacturer thereof. As shown in FIGS. 1 and 2, a slide valve 150 is incorporated into the handle 110, shank 120 and brush head 130. It is conceivable that the slide valve 150 may be incorporated into the shank 120 and brush head 130 only or the brush head 130 only.

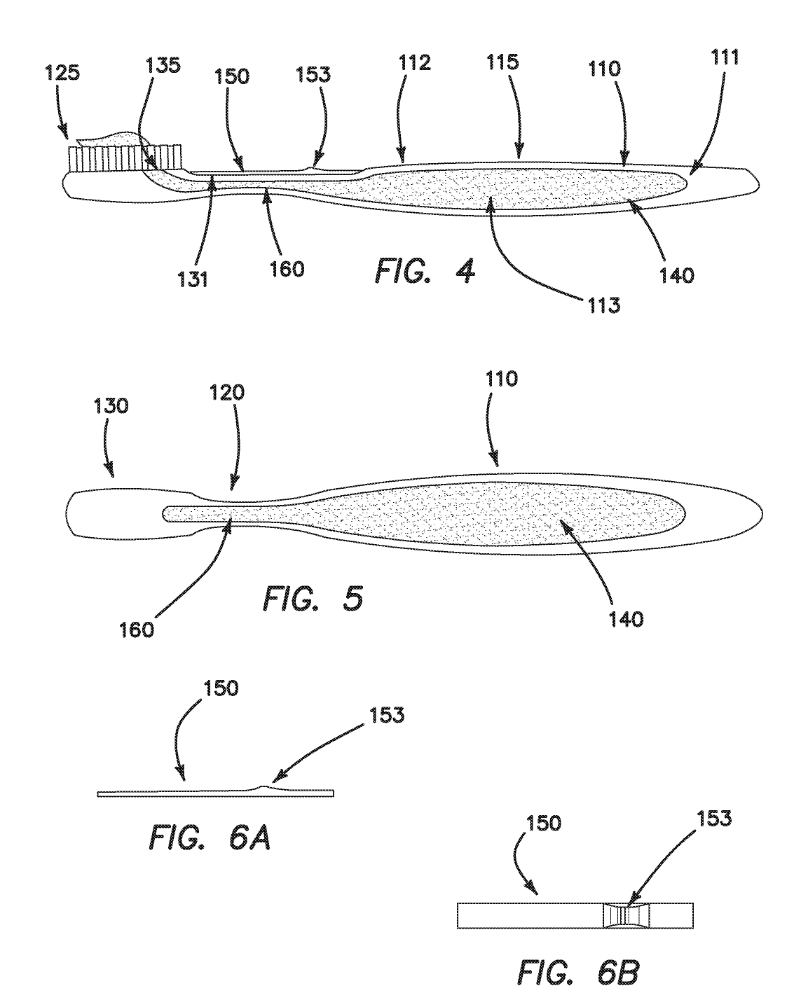

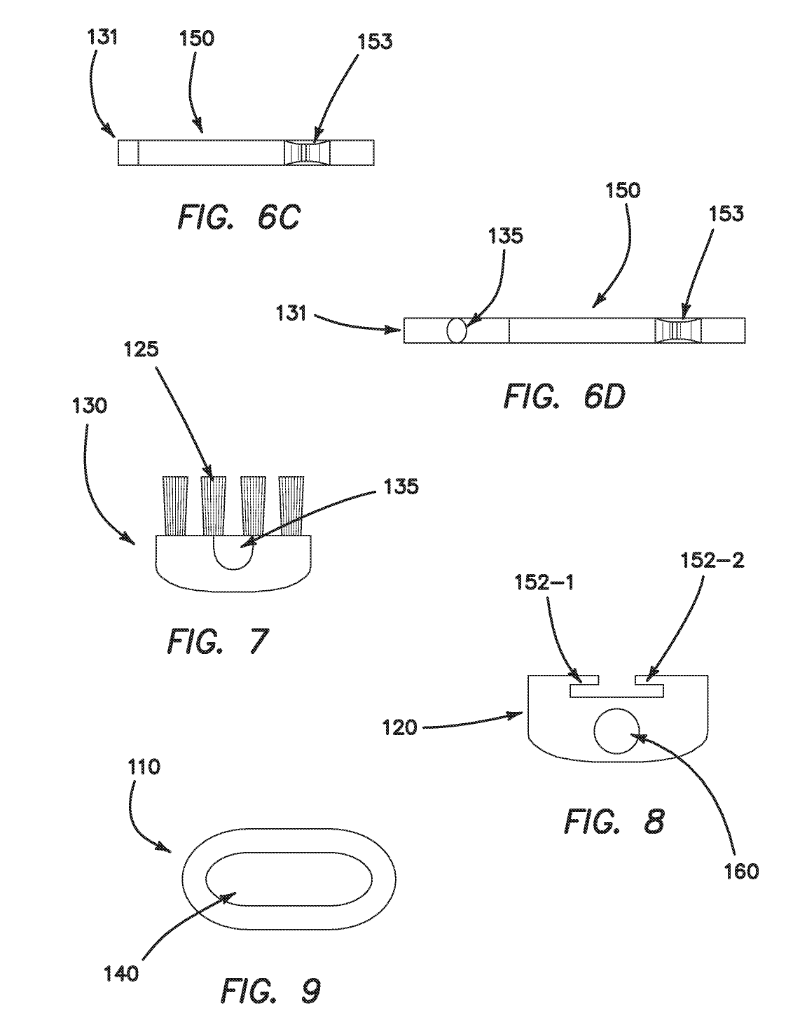

Now referring to FIG. 4, in addition to FIGS. 1-3, the slide valve 150 is slidably set into recess 131 extending from said handle 110 through said shank 120 and into said brush head 150. As best shown in FIGS. 6B and 8, in one embodiment, the slide valve 150 is slidably joined to the toothbrush 100 via a pair of parallel slots 152-1, 152-2 into which the rectangular sliding valve 150 resides. The thickness of the slide valve 150 is dimensioned just large enough to create a friction-based relationship with the parallel slots 152-1, 152-2 such that the slide valve 150 remains in a current position until acted upon by an eternal force (i.e., a user applying pressure with a thumb or finger to slide it). The slide valve 150 is thus able to slide slightly (as indicated by arrow A) between a closed position (see FIG. 6C) and open position (see FIG. 6D). A finger bump 153 on the slide valve 150 provides a mechanism for easily controlling the slide valve 150. For reasons detailed below, when the slide valve 150 is an open position, opening 135 in said brush head 130 is exposed and, when in a closed position, opening 135 is covered and generally sealed such that brushing may occur without toothpaste leakage and drying out of contained toothpaste. While shown on a front of the toothbrush 100, it is conceivable that the slide valve 150 may be on a side or rear of the toothbrush 100.

Now referring to FIGS. 4 and 5, passageway 160 extends from said chamber 140 to said opening 135 in said brush head 130. The passageway 160 provides a path for toothpaste contained within said toothpaste chamber 140 to travel to, and dispense through, said opening 135 into the bristles 125 extending from said brush head 130. The opening 135 may be positioned at any point beneath the bristles 125 so that the toothpaste is immediately available to use when dispensed. FIG. 7 shows a cross-sectional view of the brush head 130 near the opening 135. While passageway 160 is shown, in an alternative embodiment, the toothpaste chamber 140 may directly extend to the opening 135 such that a defined passageway is not necessary.

Dispensing the toothpaste from toothpaste chamber 140 is facilitated by a pliable portion 115 on the front (and/or rear) of the handle 110. In one embodiment, except for the pliable portion 115, the handle 110 is rigid (e.g., hard plastic) or at least less pliable than the pliable portion 115. In another embodiment, a majority of, or all of, the handle may be pliable. Dispensing the toothpaste comprises the simple task of (i) opening the slide valve 150 to expose the opening 135 in the brush head 130; and (ii) applying downward and/or forward pressure (towards the brush head 130) to said pliable portion 115 nearest the end 111 of handle 110 such that the contained toothpaste is forced from the toothpaste chamber 140 into passageway 160 and out of opening 135 into the bristles 125 (see, PRESS arrows in FIG. 1). In one embodiment, after the application of external force, the pliable portion 115 returns to its original non-depressed position. FIG. 4 shows toothpaste dispensed on the bristles 125 from toothpaste chamber 140. Depending on an amount of the handle 110 being fabricated of pliable material, squeezing, rather than simple pressure, may also be used to dispense the toothpaste. Assuming toothpaste has not been exhausted after a current use, subsequent uses may require the application of downward and/or forward pressure nearer a middle 112 of the pliable portion 115 or nearer to the point the passageway 160 joins the toothpaste chamber 140. Pliable as used herein means soft, flexible or otherwise malleable by application of modest pressure by a user and may be fabricated of rubber, elastic, polymers and the like.

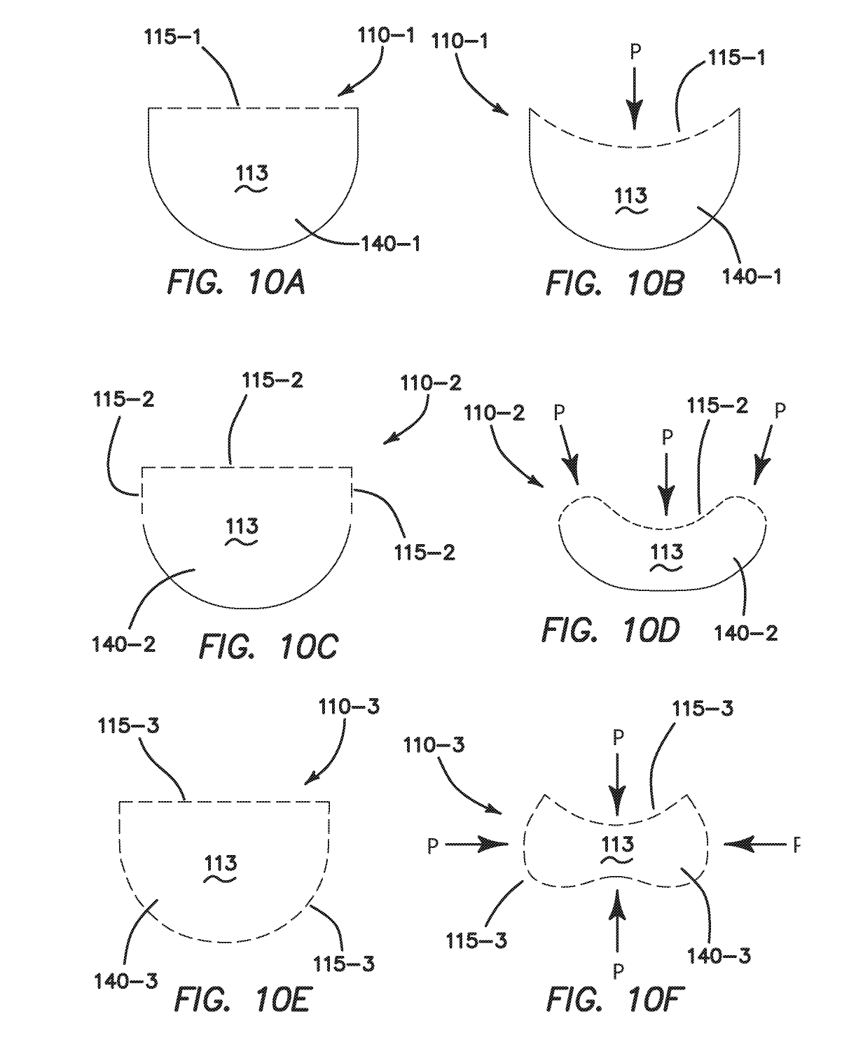

FIGS. 10A-10F show exemplary toothbrush handles 110-1 through 110-3 according to the embodiments of the present invention. FIGS. 10A and 10B show cross-sectional views along the handle 110-1 through 110-3 in a normal position and depressed position. Specifically, FIG. 10A and 10B show handle 110-1 having a pliable portion 115-1 (shown in dotted lines) along a face of the handle 110-1. When depressed (arrow P), as shown in FIG. 10B, the pliable portion 115-1 moves downward forcing the toothpaste 113 from the toothpaste chamber 140-1 into passageway and onto the toothbrush the bristles. FIGS. 10C and 10D show handle 110-2 having a pliable portion 115-2 (shown in dotted lines) along a face and sides of the handle 110-2. When depressed and squeezed (arrows P), as shown in FIG. 10D, the pliable portion 115-2 moves downward and inward forcing the toothpaste 113 from the toothpaste chamber 140-2 into passageway and onto the toothbrush the bristles. FIGS. 10E and 10F show handle 110-3 having a pliable portion 115-3 (shown in dotted lines) along a face, sides and rear of the handle 110-3 (i.e., entire handle 110-3 pliable). When depressed and squeezed (arrows P), as shown in FIG. 10E, the pliable portion 115-3 moves downward, inward and upward forcing the toothpaste 113 from the chamber 140-3 into passageway and onto the toothbrush the bristles. Despite the figures herein, there are no limitations on the cross-sectional shape of the handle.

In one embodiment, the toothbrush 100 is fabricated using two-shot injection molding which allows an article to be fabricated of two different materials (e.g., polymers). Other manufacturing techniques may be used as well. Regardless of the manufacturing technique used, the toothpaste chamber 140 is filled with toothpaste during the manufacturing stage such that when the toothpaste is exhausted the toothbrush 100 may be discarded. Accordingly, in one embodiment, depending on the dimensions of the toothpaste chamber 140, it is envisioned that the toothbrush may be used 3-5 times before being discarded. In another embodiment, the handle 110 and toothpaste chamber 140 may contain enough toothpaste to allow the toothbrush 100 to be used for weeks and/or as long as the useful life of the bristles 125.

Although the invention has been described in detail with reference to several embodiments, additional variations and modifications exist within the scope and spirit of the invention as described and defined in the following claims.

1. A toothbrush comprising:
a brush head having bristles extending therefrom;
a handle defining a toothpaste chamber therein;
a valve configured to open and close an opening in said brush head; and
wherein at least a portion along a length of said handle is fabricated of a pliable material such that toothpaste contained within said toothpaste chamber defined by said handle can be dispensed on to said brush head via said opening by application of pressure to said pliable material along said handle.

2. The toothbrush of claim 1 further comprising a passageway extending from the toothpaste chamber to the opening in said brush head.

3. The toothbrush of claim 1 further comprising a pair of slots positioned to slidably receive said valve.

4. The toothbrush of claim 1 wherein, other than said pliable material, said handle is fabricated of rigid material.

5. The toothbrush of claim 1 wherein said handle and brush head is fabricated of two-shot injection molding.

6. A toothbrush comprising:
a brush head having bristles extending therefrom;
a handle defining a toothpaste chamber;
a slide valve configured to open and close an opening in said brush head;
a passageway extending from said toothpaste chamber to said opening in said brush head; and
wherein said handle includes a pliable portion along a length thereof such that toothpaste contained within said toothpaste chamber defined by said handle can be dispensed on to said brush head via said opening by application of pressure to said pliable portion of said handle.

7. The toothbrush of claim 6 further comprising a pair of slots positioned to slidably receive said valve.

8. The toothbrush of clam 6 said slide valve extends from said handle to said brush head.

9. The toothbrush of claim 6 wherein said handle and brush head is fabricated of two-shot injection molding.

10. A toothbrush comprising:
a brush head having bristles extending therefrom;
a handle having a toothpaste chamber therein, said handle having a pliable portion along a length thereof proximate to said toothpaste chamber therein;
a valve configured to open and close an opening in said brush head;
a passageway extending from said toothpaste chamber to said opening in said brush head; and
wherein toothpaste contained within said toothpaste chamber can be dispensed on to said brush head via said passageway and opening by application of pressure to said pliable portion.

11. The toothbrush of claim 10 further comprising a pair of slots positioned to slidably receive said valve.

12. The toothbrush of claim 10 wherein said slide valve extends from said handle to said brush head.

13. The toothbrush of claim 10 wherein said handle and brush head is fabricated of two-shot injection molding.
